(19) United States
(12) Patent Application Publication
(10) Pub. No.: US 2021/0365576 A1
(43) Pub. Date: Nov. 25, 2021

(54) MULTISTAGE DATABASE SECURITY

(71) Applicant: T-Mobile USA, Inc., Bellevue, WA (US)

(72) Inventor: Cameron Byrne, Seattle, WA (US)

(21) Appl. No.: 16/877,788

(22) Filed: May 19, 2020

(51) Int. Cl. G06F 21/62; G06F 21/60; G06F 16/23

(52) U.S. Cl. CPC G06F 21/6218; G06F 16/2379; G06F 21/602

(57) ABSTRACT

A data storage system secures information by storing records in a long term storage database to which only the data storage system can access and moving them into a working database where access requestors can work with them. As such, only records in the working database may be exposed. Further, unauthorized people attempting to gain access may only discover accesses going to the working database and may be less likely to discover and attempt to access the long term storage database. The records may be individually encrypted and/or otherwise controlled to require individual authorization prior to decryption and/or copying to the working database. As such, access requestors may be unable to request records to be moved absent involvement of the appropriate authorizer or authorization provider. Additionally, this may allow separate tracking, trend analysis, and alarms based on profiles of typical access for each of the databases.

### FIELD

The described embodiments relate generally to data security. More particularly, the present embodiments relate to multistage security restriction of database records.

### BACKGROUND

As time goes on, more and more information is tracked, recorded, stored, and analyzed. This information is typically stored and managed in one or more databases or other data stores. These databases are typically managed by one or more storage controllers that direct how the information is stored, accessed, updated, and so on.

For example, a national retail chain may store a database of customer transactions. The database may include information on all transactions customers engage in, the items that were purchased, customer data, payment data, locations where purchases were made, dates of purchases, and other such information. This information may be used for accounting or other record keeping purposes, in order to facilitate returns, in order to target future advertising, and so on.

### SUMMARY

The present disclosure relates to a data storage system that secures information by storing records in a first data store or a long term storage database to which only the data storage system can access and moving them into a second data store or temporary database or working database where access requestors can work with them. As the data storage system allows access requestors to access the working database, only records in the working database may be exposed to unauthorized access. Further, unauthorized people attempting to gain access may only discover accesses going to the working database and may be less likely to discover and attempt to access the long term storage database. The records in the long term storage database may be individually encrypted and/or otherwise controlled to require individual authorization (such as from the person associated with the record) prior to decryption and/or copying to the working database. As such, access requestors may be unable to request records to be moved absent involvement of the appropriate authorizer or authorization provider. Additionally, this data storage partitioning may allow separate tracking, trend analysis, and alarms based on profiles of typical access for each of the working database and the long term storage database.

In various embodiments, a multistage secure data storage system includes a working database, a long term storage database that stores multiple encrypted records, and at least one data storage controller. The at least one data storage controller adds a decrypted version of an encrypted record from the multiple encrypted records from the long term storage database to the working database upon receipt of access authorization to the encrypted record, allows access by an access requestor to the decrypted version of the encrypted record from the working database, updates the encrypted record in the long term storage database with any changes to the decrypted version of the encrypted record, and expunges the decrypted version of the encrypted record from the working database.

In some examples, the at least one data storage controller receives the access authorization from an authorization provider other than the access requestor. In various implementations of such examples, the at least one data storage controller receives the access authorization from the authorization provider via the access requestor. In some implementations of such examples, the at least one data storage controller prompts the authorization provider for the access authorization in response to a request from the access requestor.

In a number of examples, the long term storage database is communicably isolated from the access requestor. In some examples, each of the multiple encrypted records is separately encrypted. In various examples, each of the multiple encrypted records is accessed using separate access authorizations.

In some embodiments, a multistage secure data storage system includes a first data store, a second data store, at least one non-transitory storage medium that stores instructions, and at least one processor. The at least one processor executes the instructions to decrypt a record from multiple encrypted records stored in the first data store upon receipt of access authorization to the record; move a copy of the record to the second data store, allow an access request to the second data store from an access requestor; deny access requests to the first data store from the access requestor; and, upon occurrence of a time period, delete the copy from the first data store.

In various examples, the multiple encrypted records stored in the first data store are encrypted using at least one first encryption scheme and the copy of the record in the second data store is encrypted using at least one second encryption scheme. In some examples, decryption of a first record of the multiple encrypted records stored in the first data store uses a first access authorization and decryption of a second record of the multiple encrypted records stored in the first data store uses a second access authorization. In a number of examples, the at least one processor triggers a first alarm if first data store access attempts deviate from first data store access metrics and a second alarm if second data store access attempts deviate from second data store access metrics.

In some examples, the first data store and the second data store are stored in the same storage medium. In a number of examples, the at least one processor is communicably connected to the first data store via a closed network and the first data store via an open network. In various examples, the first data store is stored in a first cloud storage partition and the second data store is stored in a second cloud storage partition.

In a number of embodiments, a method for operating a multistage secure data storage system includes maintaining multiple records in a long term storage database; upon receiving access authorization to a record of the multiple records, moving a copy of the record to a short term storage database; and allowing an access requestor access to the copy of the record in the short term storage database.

In some examples, the method further includes determining that the access requestor made a modification to the copy of the record in the short term storage database and updating the record in the long term storage database using the modification. In a number of implementations of such examples, the modification includes at least one of updating an address or updating payment information.

In various examples, the access authorization is received from a customer and the access requestor is a customer service agent. In some examples, the multiple records are telecommunication company records. In a number of examples, the method further includes purging the copy of the record from the short term storage database after the access is complete.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example multistage secure data storage system.

FIG. 2 depicts a flow chart illustrating a first example method for operating a multistage secure data storage system. This method may be performed by the system of FIG. 1.

FIG. 3 depicts a flow chart illustrating a second example method for operating a multistage secure data storage system. This method may be performed by the system of FIG. 1.

FIG. 4 depicts a flow chart illustrating a third example method for operating a multistage secure data storage system. This method may be performed by the system of FIG. 1.

FIG. 5 depicts a flow chart illustrating a fourth example method for operating a multistage secure data storage system. This method may be performed by the system of FIG. 1.

FIG. 6 depicts a flow chart illustrating a fifth example method for operating a multistage secure data storage system. This method may be performed by the system of FIG. 1.

FIG. 7 depicts a block diagram of example components that may be used to implement the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Security is a particular concern as more and more information is stored. The information has to be accessible in order to be used and to facilitate the various functions that can be performed using the information, but the consequences of unauthorized access can be dire. Money and time lost due to fraud or theft or combatting such can be devastating, and liability for negligently or recklessly allowing such unauthorized access can be severe. Perceived or real security issues can also hamper the ability to obtain information, as people may not be willing to share information if sufficient steps will not be taken to protect that information from malicious use.

For example, a telecommunications company may keep one or more customer databases. Such databases could include information on one or more telecommunications accounts, customer data (such as one or more addresses, phone numbers, social security numbers, and so on), credit card numbers or other payment data, and so on. Customer service representatives may need to access the information in the customer database in order to be able to perform services for customers, but customer service representatives may also access the information for unauthorized purposes. Customer service representatives could misappropriate customer information, clone subscriber identification module (or “SIM”) cards, and so on. Hackers could also exploit security flaws in order to obtain the customer information. Such unauthorized access to the information or unauthorized use of authorized access presents a significant problem for entities who store information. However, the present disclosure discloses techniques that ameliorate and/or overcome such issues.

The present disclosure relates to a data storage system that secures information by storing records in a first data store or a long term storage database to which only the data storage system can access and moving them into a second data store or temporary database or working database where access requestors can work with them. As the data storage system allows access requestors to access the working database, only records in the working database may be exposed to unauthorized access. Further, unauthorized people attempting to gain access may only discover accesses going to the working database and may be less likely to discover and attempt to access the long term storage database. The records in the long term storage database may be individually encrypted and/or otherwise controlled to require individual authorization (such as from the person associated with the record) prior to decryption and/or copying to the working database. As such, access requestors may be unable to request records to be moved absent involvement of the appropriate authorizer or authorization provider. Additionally, this data storage partitioning may allow separate tracking, trend analysis, and alarms based on profiles of typical access for each of the working database and the long term storage database.

In this way, the system may be able to provide improved authorized access to the information while more securely preventing unauthorized access and/or use. The system may thus be able to perform additional functions that the system would not previously have been able to perform absent the technology disclosed herein. This may enable the system to operate more efficiently while consuming fewer hardware and/or software resources as more resource consuming and/or burdensome security and/or access techniques could be omitted. Further, other security hardware and/or other components may be omitted while still enabling appropriate secure access, reducing unnecessary hardware and/or software components and providing greater system flexibility.

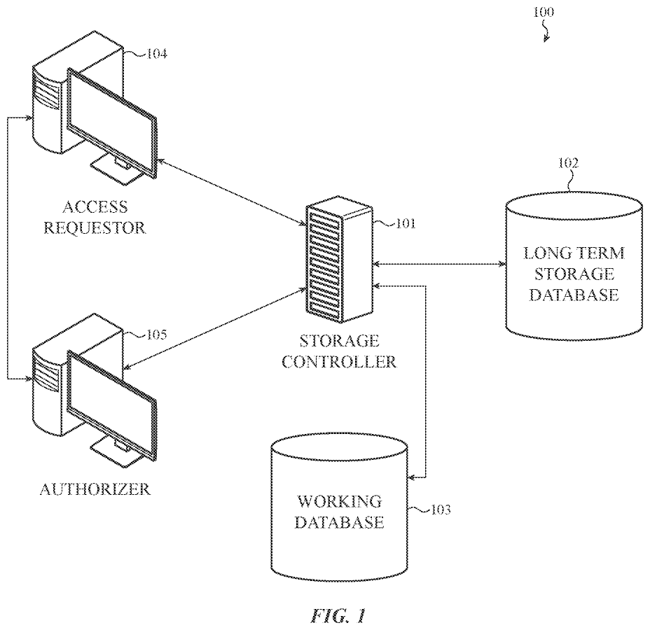

These and other embodiments are discussed below with reference to FIGS. 1-7. However, those skilled in the art will readily appreciate that the detailed description given herein with respect to these Figures is for explanatory purposes only and should not be construed as limiting.

FIG. 1 depicts an example multistage secure data storage system. The system 100 may include one or more storage controllers 101 that may communicate with one or more long term storage databases 102 and one or more working databases 103. The storage controller 101 may also communicate with one or more access requestors 104 and/or one or more authorizers 105 or authorization providers in order to provide access to the working database 103.

The storage controller 101 may secure information by storing records in the long term storage database 102 to which only the storage controller 101 can access and moving them into a the working database 103 where the access requestor 104 (such as a data processing program or service used by customer service representatives or agents) can work with them. The storage controller 101 may communicably isolate the long term storage database 102 from the access requestor 104, the authorizer 105, and/or others. The storage controller 101 may move the records upon request of the access requestor 104, upon request of the authorizer 105, when otherwise notified that the record will be used by the access requestor 104, and so on.

As the storage controller 101 may allow access requestors 104 to access the working database 103, only records in the working database 103 may be exposed to unauthorized access. Further, unauthorized people attempting to gain access may only discover accesses going to the working database 103 and may be less likely to discover and attempt to access the long term storage database 102.

In this way, the system 100 may be able to provide improved authorized access to the information while more securely preventing unauthorized access and/or use. The system may thus be able to perform additional functions that the system would not previously have been able to perform absent the technology disclosed herein. This may enable the system 100 to operate more efficiently while consuming fewer hardware and/or software resources as more resource consuming and/or burdensome security and/or access techniques could be omitted. Further, other security hardware and/or other components may be omitted while still enabling appropriate secure access, reducing unnecessary hardware and/or software components and providing greater system flexibility.

Subsequently, the storage controller 101 may purge, delete, expunge, and/or otherwise remove the record from the working database 103. The storage controller 101 may perform such an operation upon the occurrence of a condition, such as the expiration of a time period (such as one hour, one day, and so on), upon completion of access by the access requestor 104, and so on.

In some examples, the access requestor 104 may make one or more changes, modifications, updates, and so on to the record in the working database 103. In such an example, the storage controller 101 may update the record in the long term storage database 102 with any changes, modifications, updates, and so on made to the record in the working database 103. In some implementations, the storage controller 101 may determine whether or not such a change, modification, update, and so on has been made to a record in the working database 103 upon determining to purge, delete, expunge, and/or otherwise remove the record from the working database 103. If not, the storage controller 101 may purge, delete, expunge, and/or otherwise remove the record from the working database 103. Otherwise, the storage controller 101 may update the record in the long term storage database 102 with the change, modification, update, and so on made to the record in the working database prior to purging, deleting, expunging, and/or otherwise removing the updated record in the long term storage database 102 with any changes, modifications, updates, and so on made to the record in the working database 103. Various configurations are possible and contemplated without departing from the scope of the present disclosure.

The records in the long term storage database 102 may be individually encrypted and/or otherwise controlled to require individual authorization (such as a personal identification number or “PIN”, password, permission, and/or other individual authorization information from the person or entity associated with the record) prior to decryption and/or copying to the working database 103. As such, access requestors may be unable to request records to be moved absent involvement of the appropriate authorizer 105.

For example, the authorizer 105 may submit authorization to the storage controller 101 to allow the access requestor 104 access to the record in the long term storage database 102. The storage controller 101 may respond by moving the record from the long term storage database 102 to the working database 103, whereupon the access requestor 104 may be able to access the record in the working database 103. By way of another example, the access requestor 104 may request the storage controller 101 to provide access to the record and the storage controller 101 may prompt the authorizer 105 to provide authorization. In another example, the access requestor 104 may request access from the storage controller 101 and the storage controller 101 may provide a request for authorization that the access requestor 104 may provide to the authorizer 105. In such an example, the authorizer 105 may provide the authorization directly to the storage controller 101, may provide the authorization to the storage controller 101 via the access requestor 104, and so on. Various configurations are possible and contemplated without departing from the scope of the present disclosure.

In some examples, the storage controller 101 may encrypt records that the storage controller 101 moves into the working database 103. In some implementations, the encryption scheme used may be the same as that used to encrypt records stored in the long term storage database 102. In other implementations, a different encryption scheme may be used. For example, a less computationally intensive encryption scheme may be used to encrypt records stored in the working database 103 than that used to encrypt records stored in the long term storage database 102 as less information is stored for less time in the working database 103. Various configurations are possible and contemplated without departing from the scope of the present disclosure.

Additionally, this data storage partitioning may allow separate tracking, trend analysis, and alarms based on profiles of typical access for each of the working database 103 and the long term storage database 102. Typical accesses made to the working database 103 and the long term storage database 102 may be different in frequency, source, timing, and/or other characteristics. By being able to evaluate accesses separately, the storage controller 101 may be better able to identify deviations from normal and/or typical access. For example, the storage controller 101 may be able to provide a long term data storage alarm when non-typical access (i.e., access that deviates from typical access) to the long term storage database 102 is detected and a working database alarm when non-typical access (i.e., access that deviates from typical access) to the working database 103 is detected. Various configurations are possible and contemplated without departing from the scope of the present disclosure.

Although the above describes the storage controller 101 moving one or more records from the long term storage database 102 to the working database 103, it is understood that this is an example. In some implementations, the storage controller 101 may make a copy of the record in the working database 103 without altering the record in the long term storage database 102. In other implementations, the storage controller 101 may “check out” the record and actually move the record from the long term storage database 102 to the working database 103, subsequently moving the record (and/or any changes, updates, or modifications made while the record is stored in the working database 103) back to the long term storage database 102. Various configurations are possible and contemplated without departing from the scope of the present disclosure.

Further, although the long term storage database 102 and the working database 103 are illustrated and described as databases, it is understood that these are examples. In various implementations, any first and second data stores (such as a long term data store and a temporary data store, a primary data store and a cache data store, and so on) may be used that may or may not implement a database structure. Various configurations are possible and contemplated without departing from the scope of the present disclosure.

Additionally, although the above illustrates and describes information in the context of records, it is understood that this is an example. In some implementations, any kind of information may be stored in the long term storage database 102 and/or the working database 103 without being stored in one or more records. Various configurations are possible and contemplated without departing from the scope of the present disclosure.

By way of an illustration, a telecommunications company customer service representative or agent may need to access billing information in order to assist customers. On any given day for the telecommunications company, only a small percentage of billing information for customers may be accessed. The vast majority of billing information may not need to be accessed. As such, for the small percentage of customers that call a customer service representative or come into a retail store, their billing information may be transferred from long term storage to short term storage. This export process may be triggered by customer authentication, such as by providing PIN numbers. While in short term storage, the customer and/or the customer service representative or agent may expose the customer's billing information to be manipulated in short term storage, such as updating the address or credit card on record. When the transaction is complete, the customer's billing information may be returned to the long term storage and expunged from the short term storage. As the billing information may be transferred on a per-record level authentication, only authorized records may be transferred without exposure of unauthorized records in the long term storage.

By way of another illustration, a mobile customer calls customer care and authenticates himself to the system with his phone number and PIN. Based on this authentication, the customer's account record may be transferred from a long term secure encrypted database to a short term database that a customer service agent may access. The customer may speak with the customer service agent and update his address on file. Once the call is over, the short term database may update the long term secure encrypted database and expunge the information from the short term database. In such a system, a rogue and malicious customer service agent may attempt to access the records of a celebrity and may not be able to as the tools accessible to the customer service agent may only access the short term database and the celebrity has not authenticated to transfer the celebrity's records to the short term database. Also in such a system, a hacker may exploit a security vulnerability to take unauthorized control of a company server and may want to dump available information, steal it, and/or hold it for ransom. The hacker may see that the customer service agent or representative tools are accessing the short term database and takes control of that, exporting the information from the short term database. This may only be a small portion of the data stored in the long term secure encrypted database and may not be worth much to the hacker. The long term secure encrypted database may have the data that would be valuable to the hacker, but since that requires per customer authentication to decrypt all the records, the hacker may give up since he may not be able to exfiltrate and manually decrypt all of the data to hold for ransom.

Although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the long term storage database 102 and the working database 103 being separate components. However, it is understood that this is an example. In some implementations, the long term storage database 102 and the working database 103 may be different partitions of the same data storage medium and/or component and/or clusters of components, different partitions of a cloud storage system, and so on. Various configurations are possible and contemplated without departing from the scope of the present disclosure.

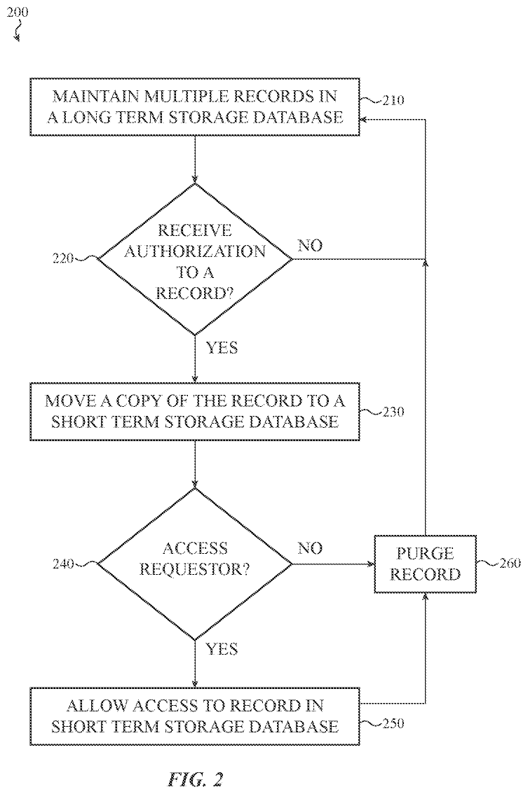

FIG. 2 depicts a flow chart illustrating a first example method 200 for operating a multistage secure data storage system. This method 200 may be performed by the system 100 of FIG. 1.

At operation 210, an electronic device (such as the storage controller 101 of FIG. 1) may maintain multiple records in a long term storage database. At operation 220, the electronic device may determine whether access authorization for a record of the multiple records stored in the long term storage database is received. If not, the flow may return to operation 210 where the electronic device continues maintaining the multiple records in the long term storage database. Otherwise, the flow may proceed to operation 230.

At operation 230, after the electronic device determines that access authorization for a record of the multiple records stored in the long term storage database is received, the electronic device may move a copy of the record to a short term storage database. This may involve decrypting the record as part of copying the record. This may also involve encrypting the copy of the record. In some examples, the record in the long term storage database may be encrypted using a different encryption scheme than that used to encrypt the copy of the record.

At operation 240, the electronic device may determine whether or not an access requestor attempts to access the copy of the record in the short term storage database. If so, the flow may proceed to operation 250. Otherwise, the flow may proceed to operation 260 where the electronic device may purge the copy of the record from the short term storage database before the flow returns to operation 220 and the electronic device continues maintaining the multiple records in the long term storage database.

At operation 250, after the electronic device determines that an access requestor attempts to access the copy of the record in the short term storage database, the electronic device may allow access to the copy of the record in the short term storage database before the flow proceeds to operation 260 where the electronic device may purge the copy of the record from the short term storage database.

In various examples, this example method 200 may be implemented as a group of interrelated software modules or components that perform various functions discussed herein. These software modules or components may be executed within a cloud network and/or by one or more computing devices, such as the storage controller 101 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as purging the copy of the record from the short term storage database after allowing access to the copy of the record in the short term storage database. However, it is understood that this is an example. In some implementations, the electronic device may update the record in the long term storage database for any changes, updates, modifications, and so on that were made to the copy of the record in the short term storage database before purging the copy of the record from the short term storage database. Various configurations are possible and contemplated without departing from the scope of the present disclosure.

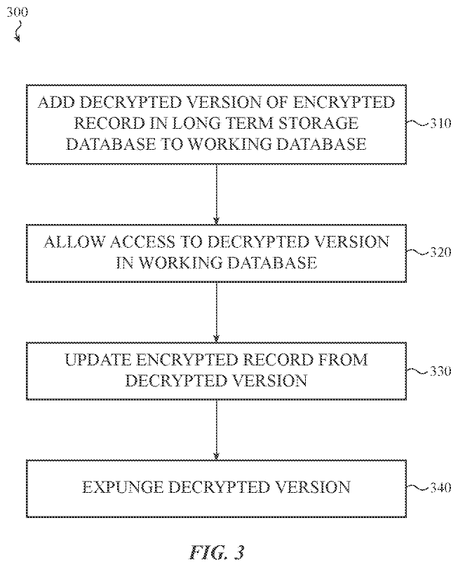

FIG. 3 depicts a flow chart illustrating a second example method 300 for operating a multistage secure data storage system. This method 300 may be performed by the system 100 of FIG. 1.

At operation 310, the electronic device (such as the storage controller 101 of FIG. 1) may add a decrypted version of an encrypted record in a long term storage database to a working database. The electronic device may add the decrypted version of the encrypted record upon request (such as by a potential accessor, a person or entity associated with the encrypted record, and so on), when otherwise notified that the record will be used, and so on.

At operation 320, the electronic device may allow access to the decrypted version in the working database. The access may include making an update to the decrypted version in the working database. At operation 330, the electronic device may update the encrypted record in the long term storage database from the decrypted version.

At operation 340, the electronic device may expunge the decrypted version from the working database. The electronic device may expunge the decrypted version when access is complete (such as in response to a notification that the access is complete), after lapse of a time period, and so on.

In various examples, this example method 300 may be implemented as a group of interrelated software modules or components that perform various functions discussed herein. These software modules or components may be executed within a cloud network and/or by one or more computing devices, such as the storage controller 101 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as expunging the decrypted version from the working database. However, it is understood that this is an example. In some implementations, the electronic device may expunge one or more pointers to the decrypted version in the working database without expunging the decrypted version from the working database. In this way, the decrypted version may no longer be accessible from the working database and may be overwritten by subsequent writes to the working database. Various configurations are possible and contemplated without departing from the scope of the present disclosure.

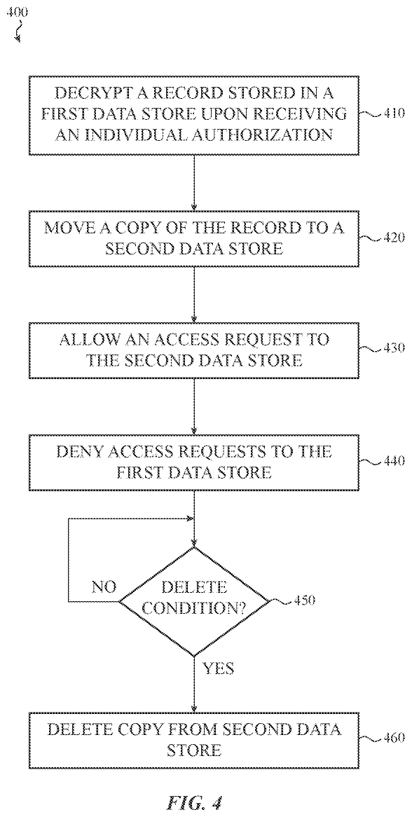

FIG. 4 depicts a flow chart illustrating a third example method 400 for operating a multistage secure data storage system. This method 400 may be performed by the system 100 of FIG. 1.

At operation 410, the electronic device (such as the storage controller 101 of FIG. 1) may decrypt a record stored in a first data store upon receiving an individual authorization. Multiple records stored in the first data store may require separate individual authorizations in order to be decrypted.

At operation 420, the electronic device may move a copy of the record to a second data store. In some examples, the copy of the record may be re-encrypted before moving.

At operation 430, the electronic device may allow an access request to the second data store. The access request may be an access request to read from and/or write to the copy of the record moved to the second data store in operation 420. At operation 440, the electronic device may deny access requests to the first data store.

At operation 450, the electronic device may determine whether or not one or more delete conditions occurs. Such delete conditions may include the expiration of a time period (such as one hour, one day, and so on), completion of access to the copy of the record stored in the second data store, and so on. If not, the flow may return to operation 450 where the electronic device may again determine whether or not one or more delete conditions occur. Otherwise, the flow may proceed to operation 460.

At operation 460, after the electronic device determines that one or more delete conditions occurs, the electronic device may delete the copy of the record from the second data store. In some examples, if the copy of the record in the second data store was changed after being moved to the second data store, the electronic device may update the record stored in the second data store before, during, or after deleting the copy of the record from the second data store. Various configurations are possible and contemplated without departing from the scope of the present disclosure.

In various examples, this example method 400 may be implemented as a group of interrelated software modules or components that perform various functions discussed herein. These software modules or components may be executed within a cloud network and/or by one or more computing devices, such as the storage controller 101 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, operation 440 is illustrated and described as the electronic device denying an access request to the first data store. However, it is understood that this is an example. In some implementations, the electronic device may not receive an access request to the first data store. In such implementations, the operation 440 may be omitted. Various configurations are possible and contemplated without departing from the scope of the present disclosure.

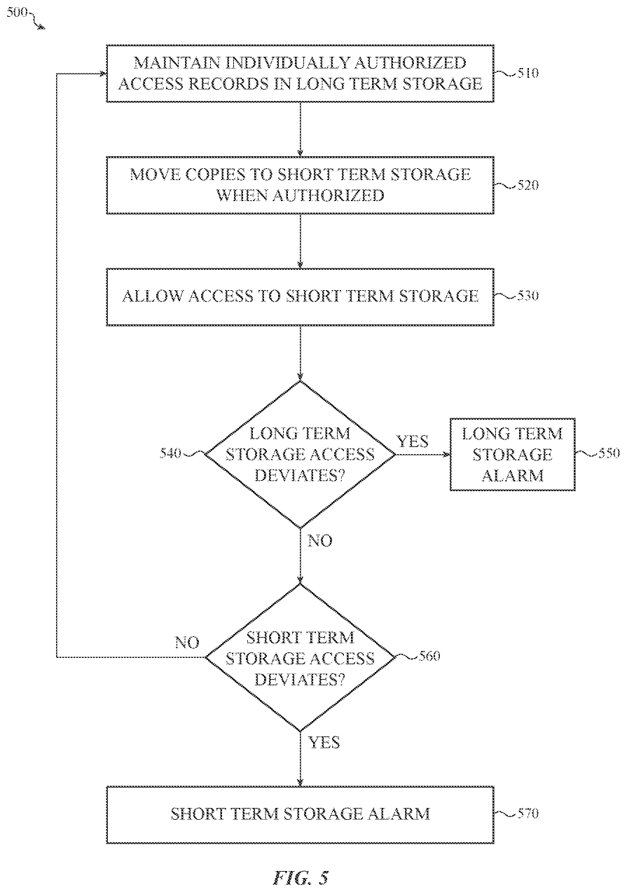

FIG. 5 depicts a flow chart illustrating a fourth example method 500 for operating a multistage secure data storage system. This method 500 may be performed by the system 100 of FIG. 1.

At operation 510, the electronic device (such as the storage controller 101 of FIG. 1) may maintain individually authorized access records in a long term storage. The records may be individually authorized in that each record may require separate individual authorization for access from a person or entity associated with the respective record.

At operation 520, the electronic device may move copies of the records from the long term storage to a short term storage when respective individual authorizations associated with the respective individual records are received. At operation 530, the electronic device may allow access to the copies of the records in the short term storage. The electronic device may also remove the copies of the records from the long term storage, such as periodically, when access is complete, and so on.

At operation 540, the electronic device may determine whether or not long term storage access deviates from typical access. For example, the electronic device may track metrics of accesses to the long term storage over time. These metrics may be used to determine a profile of how typical accesses to the long term storage behave. If access is different from this determined profile for the long term storage, the electronic device may determine that the long term storage access deviates from typical access to the long term storage. If so, the flow may proceed to operation 550 where the electronic device may trigger a long term storage alarm. Otherwise, the flow may proceed to operation 560.

At operation 560, the electronic device may determine whether or not short term storage access deviates from typical access. For example, the electronic device may track metrics of accesses to the short term storage over time. These metrics may be used to determine a profile of how typical accesses to the short term storage behave. If access to the short term storage is different from this determined profile for the short term storage, the electronic device may determine that the short term storage access deviates from typical access. If so, the flow may proceed to operation 570 where the electronic device may trigger a short term storage alarm. Otherwise, the flow may return to operation 510 where the electronic device continues to maintain the individually authorized access records in the long term storage.

In various examples, this example method 500 may be implemented as a group of interrelated software modules or components that perform various functions discussed herein. These software modules or components may be executed within a cloud network and/or by one or more computing devices, such as the storage controller 101 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, operation 510 is illustrated and described as the electronic device maintaining the individually authorized access records in the long term storage. However, it is understood that this is an example. In some implementations, a device other than the electronic device may maintain the individually authorized access records in the long term storage and the electronic device may only control access to the long term storage and/or the short term storage and move data between the long term storage and the short term storage. In such an implementation, operation 510 may be omitted. Various configurations are possible and contemplated without departing from the scope of the present disclosure.

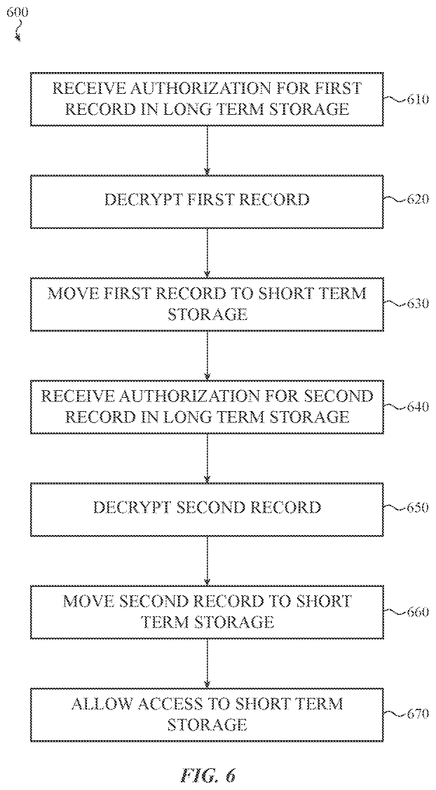

FIG. 6 depicts a flow chart illustrating a fifth example method 600 for operating a multistage secure data storage system. This method 600 may be performed by the system 100 of FIG. 1.

At operation 610, the electronic device (such as the storage controller 101 of FIG. 1) may receive authorization for a first record in a long term storage. The authorization may include a PIN, password, identification of the first record, and/or any other authorization information used to authorize access to the first record. At operation 620, the electronic device may decrypt the first record. At operation 630, the electronic device may move the first record to a short term storage.

At operation 640, the electronic device may receive authorization for a second record in a long term storage. The authorization may include a PIN, password, identification of the second record, and/or any other authorization information used to authorize access to the second record. At operation 650, the electronic device may decrypt the second record. At operation 660, the electronic device may move the second record to the short term storage.

At operation 670, the electronic device may allow access to the short term storage. The electronic device may allow access to the first record in the short term storage, the second record in the short term storage, and so on. The electronic device may subsequently remove the first record from the short term storage, remove the second record from the short term storage, update the first record in the long term storage based on a change to the first record in the short term storage, update the second record in the long term storage based on a change to the second record in the short term storage, and so on

In various examples, this example method 600 may be implemented as a group of interrelated software modules or components that perform various functions discussed herein. These software modules or components may be executed within a cloud network and/or by one or more computing devices, such as the storage controller 101 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described above as receiving the authorization for the second record in the long term storage, decrypting the second record, and moving the second record to the short term storage after receiving the authorization for the first record in the long term storage, decrypting the first record, and moving the first record to the short term storage. However, it is understood that this is an example. In some implementations, one or more of these operations may be intermixed with one or more of the other operations in a linear arrangement, a parallel arrangement, a simultaneous arrangement, a contemporaneous arrangement, and/or other various other orders. Various configurations are possible and contemplated without departing from the scope of the present disclosure.

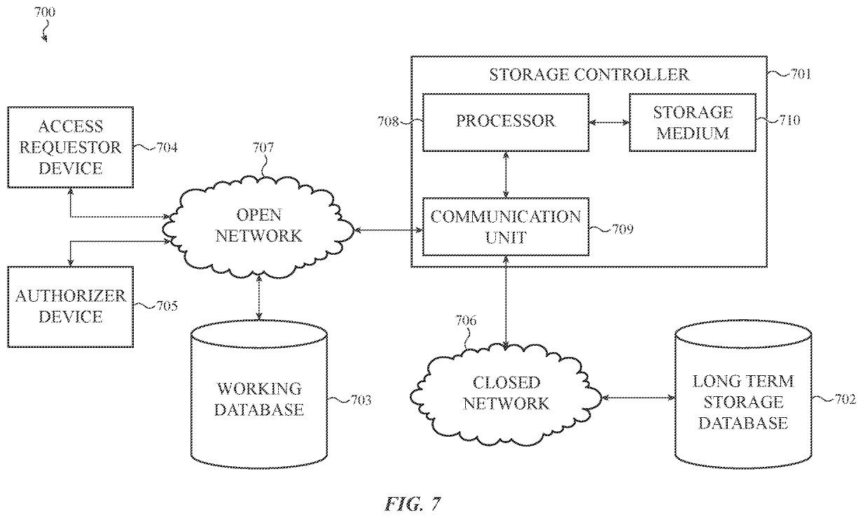

FIG. 7 depicts a block diagram 700 of example components that may be used to implement the system 100 of FIG. 1. A storage controller 701 may be communicably connected to a long term storage database 702 via a closed network 706 and a working database 703 via an open network 707. An access requestor device 704 and an authorizer device 705 may also be communicably connected to each other, to the storage controller 701, and/or to the working database 703 via an open network 707.

The storage controller 701 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The storage controller 701 may include one or more processors 708 and/or other processing units and/or controllers, one or more non-transitory storage media 710 (which may take the form of, but is not limited to, a magnetic storage medium; optical storage medium; magneto-optical storage medium; read only memory; random access memory; erasable programmable memory; flash memory; and so on), one or more communication units 709, and/or other components. The processor 708 may execute instructions stored in the non-transitory storage medium to perform various functions. Such functions may include receiving requests and/or authorizations, moving records between the long term storage database 702 and the working database 703, removing records from the working database 703, decrypting and/or encrypting records, updating records, communicating with the access requestor device 704 and/or the authorizer device 705 via the communication unit 709, and so on.

Similarly, the access requestor device 704 and/or the authorizer device 705 may be any kind of electronic device as discussed above. Such electronic devices may include one or more components, such as one or more processors, storage media, communication units, and so on.

The open network 707 may be open as the network is not used to communicably isolate one or more of the access requestor device 704, the authorizer device 705, the storage controller 701, and/or the working database 703 from one or more of each other. Conversely, the closed network 706 may be closed because it is used to communicably isolate the long term storage database 702 from the access requestor device 704, the authorizer device 705, and/or one or more other devices. The closed network 706 may not be connected to, and thus not usable for communication with, the access requestor device 704, the authorizer device 705, and/or one or more other devices. Although the closed network 706 is illustrated and described as a network, it is understood that this is an example. In some implementations, the closed network 706 may instead be a direct communication link between the storage controller 701 and the long term storage database 702 and not involve a network. In still other implementations, the long term storage database 702 may be stored in the storage medium 710 and external communication between the storage controller 701 and the long term storage database 702 may not be required. Various configurations are possible and contemplated without departing from the scope of the present disclosure.

In various implementations, a multistage secure data storage system may include a working database, a long term storage database that stores multiple encrypted records, and at least one data storage controller. The at least one data storage controller may add a decrypted version of an encrypted record from the multiple encrypted records from the long term storage database to the working database upon receipt of access authorization to the encrypted record, allow access by an access requestor to the decrypted version of the encrypted record from the working database, update the encrypted record in the long term storage database with any changes to the decrypted version of the encrypted record, and expunge the decrypted version of the encrypted record from the working database.

In some examples, the at least one data storage controller may receive the access authorization from an authorization provider other than the access requestor. In various such examples, the at least one data storage controller may receive the access authorization from the authorization provider via the access requestor. In some such examples, the at least one data storage controller may prompt the authorization provider for the access authorization in response to a request from the access requestor.

In a number of examples, the long term storage database may be communicably isolated from the access requestor. In some examples, each of the multiple encrypted records may be separately encrypted. In various examples, each of the multiple encrypted records may be accessed using separate access authorizations.

In some embodiments, a multistage secure data storage system may include a first data store, a second data store, at least one non-transitory storage medium that stores instructions, and at least one processor. The at least one processor may execute the instructions to decrypt a record from multiple encrypted records stored in the first data store upon receipt of access authorization to the record; move a copy of the record to the second data store; allow an access request to the second data store from an access requestor; deny access requests to the first data store from the access requestor; and, upon occurrence of a time period, delete the copy from the first data store.

In various examples, the multiple encrypted records stored in the first data store may be encrypted using at least one first encryption scheme and the copy of the record in the second data store may be encrypted using at least one second encryption scheme. In some examples, decryption of a first record of the multiple encrypted records stored in the first data store may use a first access authorization and decryption of a second record of the multiple encrypted records stored in the first data store may use a second access authorization. In a number of examples, the at least one processor may trigger a first alarm if first data store access attempts deviate from first data store access metrics and a second alarm if second data store access attempts deviate from second data store access metrics.

In some examples, the first data store and the second data store may be stored in the same storage medium. In a number of examples, the at least one processor may be communicably connected to the first data store via a closed network and the first data store via an open network. In various examples, the first data store may be stored in a first cloud storage partition and the second data store may be stored in a second cloud storage partition.

In a number of embodiments, a method for operating a multistage secure data storage system may include maintaining multiple records in a long term storage database; upon receiving access authorization to a record of the multiple records, moving a copy of the record to a short term storage database; and allowing an access requestor access to the copy of the record in the short term storage database.

In some examples, the method may further include determining that the access requestor made a modification to the copy of the record in the short term storage database and updating the record in the long term storage database using the modification. In a number of such examples, the modification may include at least one of updating an address or updating payment information.

In various examples, the access authorization may be received from a customer and the access requestor may be a customer service agent. In some examples, the multiple records may be telecommunication company records. In a number of examples, the method may further include purging the copy of the record from the short term storage database after the access is complete.

As described above and illustrated in the accompanying figures, the present disclosure relates to a data storage system that secures information by storing records in a first data store or long term storage database to which only the data storage system can access and moving them into a second data store or temporary database or working database where access requestors can work with them. As the data storage system allows access requestors to access the working database, only records in the working database may be exposed to unauthorized access. Further, unauthorized people attempting to gain access may only discover accesses going to the working database and may be less likely to discover and attempt to access the long term storage database. The records in the long term storage database may be individually encrypted and/or otherwise controlled to require individual authorization (such as from the person associated with the record) prior to decryption and/or copying to the working database. As such, access requestors may be unable to request records to be moved absent involvement of the appropriate authorizer or authorization provider. Additionally, this data storage partitioning may allow separate tracking, trend analysis, and alarms based on profiles of typical access for each of the working database and the long term storage database.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A multistage secure data storage system, comprising:
a working database;
a long term storage database that stores multiple encrypted records; and
at least one data storage controller that:
adds a decrypted version of an encrypted record from the multiple encrypted records from the long term storage database to the working database upon receipt of access authorization to the encrypted record;
allows access by an access requestor to the decrypted version of the encrypted record from the working database;
updates the encrypted record in the long term storage database with any changes to the decrypted version of the encrypted record; and
expunges the decrypted version of the encrypted record from the working database.

2. The multistage secure data storage system of claim 1, wherein the at least one data storage controller receives the access authorization from an authorization provider other than the access requestor.

3. The multistage secure data storage system of claim 2, wherein the at least one data storage controller receives the access authorization from the authorization provider via the access requestor.

4. The multistage secure data storage system of claim 2, wherein the at least one data storage controller prompts the authorization provider for the access authorization in response to a request from the access requestor.

5. The multistage secure data storage system of claim 1, wherein the long term storage database is communicably isolated from the access requestor.

6. The multistage secure data storage system of claim 1, wherein each of the multiple encrypted records are separately encrypted.

7. The multistage secure data storage system of claim 1, wherein each of the multiple encrypted records are accessed using separate access authorizations.

8. A multistage secure data storage system, comprising:
a first data store;
a second data store;
at least one non-transitory storage medium that stores instructions; and
at least one processor that executes the instructions to:
decrypt a record from multiple encrypted records stored in the first data store upon receipt of access authorization to the record;
move a copy of the record to the second data store;
allow an access request to the second data store from an access requestor;
deny access requests to the first data store from the access requestor; and
upon occurrence of a time period, delete the copy from the first data store.

9. The multistage secure data storage system of claim 8, wherein:
the multiple encrypted records stored in the first data store are encrypted using at least one first encryption scheme; and
the copy of the record in the second data store is encrypted using at least one second encryption scheme.

10. The multistage secure data storage system of claim 8, wherein:
decryption of a first record of the multiple encrypted records stored in the first data store uses a first access authorization; and
decryption of a second record of the multiple encrypted records stored in the first data store uses a second access authorization.

11. The multistage secure data storage system of claim 8, wherein the at least one processor triggers:
a first alarm if first data store access attempts deviate from first data store access metrics; and
a second alarm if second data store access attempts deviate from second data store access metrics.

12. The multistage secure data storage system of claim 8, wherein the first data store and the second data store are stored in a same storage medium.

13. The multistage secure data storage system of claim 8, wherein the at least one processor is communicably connected to:
the first data store via a closed network; and
the first data store via an open network.

14. The multistage secure data storage system of claim 8, wherein:
the first data store is stored in a first cloud storage partition; and
the second data store is stored in a second cloud storage partition.

15. A method for operating a multistage secure data storage system, comprising:
maintaining multiple records in a long term storage database;
upon receiving access authorization to a record of the multiple records, moving a copy of the record to a short term storage database; and
allowing an access requestor access to the copy of the record in the short term storage database.

16. The method of claim 15, further comprising:
determining that the access requestor made a modification to the copy of the record in the short term storage database; and
updating the record in the long term storage database using the modification.

17. The method of claim 16, wherein the modification comprises at least one of:
updating an address; or
updating payment information.

18. The method of claim 15, wherein:
the access authorization is received from a customer; and
the access requestor is a customer service agent.

19. The method of claim 15, wherein the multiple records are telecommunication company records.

20. The method of claim 15, further comprising purging the copy of the record from the short term storage database after the access is complete.
